(19) United States
(12) Patent Application Publication
(10) Pub. No.: US 2023/0412633 A1
(43) Pub. Date: Dec. 21, 2023

(54) Apparatus and Method for Predicting Malicious Domains

(71) Applicant: HEIMDAL SECURITY A/S, København (Copenhagen) (DK)

(72) Inventors: Valentin Rusu, Bucharest (RO); Eugeniu Cernei, Bucharest (RO)

(73) Assignee: HEIMDAL SECURITY A/S, København (Copenhagen) (DK)

(21) Appl. No.: 18/333,620

(22) Filed: Jun. 13, 2023

(30) Foreign Application Priority Data
Jun. 15, 2022 (EP) 22179244.3

(51) Int. Cl. H04L 9/40; H04L 41/16

(52) U.S. Cl. CPC H04L 63/1433; H04L 41/16

(57) ABSTRACT

A probability of a domain being malicious is calculated based on an input data set for processing in a computer system. The method comprises dataset extraction, including extraction of network data and claimable data. The method further comprises data preprocessing including transforming the network data from dense to sparse and transforming the claimable data into vectorial representations. The method also includes processing the data through a trained tree-based neural network to determine the probability of a domain being malicious.

### FIELD OF THE INVENTION

The invention relates to the area of internet security and more specifically to the area of detecting malicious domains and taking precautions against such malicious domains.

### BACKGROUND OF THE INVENTION

Security on the internet and precautions against malicious domains is a growing concern to users of the internet. Where the problem for a long time was primarily connected to the unsystematic interruption of random activities, the problem has become increasingly serious as the systematic approach to this is undertaken by criminals and consequences are often severe and may cause business interruption for longer periods and hence cause severe financial losses.

For that reason, there has also been a focus on developing technology that may predict/identify malicious domains and there are a number of these disclosed in the patent literature.

In US 2021/0377303 a method is disclosed, aiming at determining the likelihood of a domain being malicious. The method uses several components, including a trained machine learning model to predict the likelihood.

In US 2021/0360013 a method is disclosed, where a malicious domain is detected through obtaining network connection data of an electronic device and capturing log data related to at least one domain name from the network connection data.

Even though these previously known methods provide some remedy to the problem there is still a need for improvement of the technology as the accuracy and efficiency of the known methods still leave room for improvement.

For that reason, the present invention provides improvement in the accuracy and efficiency of the technology in respect of identifying the malicious domains.

### SUMMARY OF THE INVENTION

According to embodiments of the invention this is achieved through a method for calculating the probability of a domain being malicious based on an input data set for processing in a computer system, the method comprising:
Dataset extraction, comprising extracting two types of input data:
   Network data, selected from WHOIS, DNS, Reverse PTR, Domain Ranking and popularity data, Domain Authority
   Domain Word embeddings data
Data preprocessing including transforming network data from sparse to dense through feature averaging, picking the most common options, finding correlating features, or choosing a default value for unfilled data, depending on the feature type;
Data preprocessing, including transforming claimable data in a vectorial representation, e.g., through a natural language processing network such as trained neural network;
Data engineered databases for temporary storing (caching) claimable and network data; and
Data processing the preprocessed data through a trained tree-based neural network to determine the probability of a domain being malicious.

Hereby network data means data extracted from authoritative services (e.g., Whois, DNS, reverse PTR) and claimable data means data extracted from the actual domain name (embeddings).

Through such method according to the invention, the efficiency and accuracy of the process of identifying malicious domains can be significantly increased and hence provide for a safer online environment for the user of the method.

Advantageously the data preprocessing method for representing claimable data (words) as vectors, is trained unsupervised, using a model to predict a target context based on a nearby word.

The preprocessing may further comprise:
Data preprocessing method for representing claimable data (words) as vectors using n-grams; and
Data preprocessing method for filling missing data.

Hereby the data processing algorithm uses a tree-based neural network.

Advantageously the data processing algorithm uses similarity scores, gains and thresholds for determining a probability.

Preferably the classifier uses a probability distribution to determine a risk factor.

Advantageously the method further comprises a probability system for determining the risk score of a domain.

Advantageously a probability distribution system for cybersecurity to perform the method is implemented.

Advantageously a method for reading data in batches for optimizing the resources used by a system is implemented in connection with the method according to the invention.

Further advantageously a method for minimizing the memory consumption by splitting the data reading and processing in CPU, RAM, Cache and HD memory is implemented in connection with the method according to the invention.

Advantageously a method for parallel learning and inference based on splitting the data in quantiles is implemented.

Further advantageously a method for training a hierarchical classifier, a binary tree on which each leaf node represents another feature word code generated with the Huffinan tree algorithm.

Embodiments of the invention may further comprise one or more of the following features:
A machine learning pipeline adapted to generate random trees and calculates each tree's gain and similarity score based on a threshold; calculating an output value and adjusting the weights based on the error rate (loss function), and through a second-order Taylor, approximation between the error rate (loss function), gradient (first derivative of the loss function) and hessian (second derivative of the loss function), calculating the needed adjustment for improving the accuracy based on a test dataset;
A method adapted to convert odds to probabilities;
A method adapted to use logistic functions for determining a probability score;
A method adapted to use a minimizing negative likelihood function to calculate an error rate (loss function);
A tree-based neural network adapted to combine sparse data from domains and word vector representations called embeddings;
A method adapted to use a domain corpus;
A method adapted for classifying DNS attacks like typo squatting, phishing, and C&Cs using neural networks;
A method adapted to use character-level n-grams for domain embeddings extraction;
A method adapted to use cosine similarity for measuring the distance between domain embedding vectors;
A method adapted to combine unsupervised and supervised neural networks.
A method adapted to combine tree-boost networks with natural language processing networks;
A network adapted to use hidden layers for n-grams for embeddings extraction.
A network adapted to use subwords for correlation between words;
A network adapted to sum the probabilities of words and subword embeddings;
A method adapted to determine context words from a center word;
A method adapted for generating n-grams starting from a word;
A method adapted for training an unsupervised learning network on a supervised task that is ignored in the prediction step;
A method adapted to use second-order derivative of the chain rule for reduction to canonical form;
A method adapted for adjusting the vectorial representation of words to determine their correlation based on a corpus;
A method adapted for generating random vectorial representations of words starting from a corpus;
A method adapted for extracting Whois domain sparse data from authoritative services;
A method adapted for extracting DNS domain sparse data from authoritative services;
A method adapted for reverse IP lookup; and
A method adapted for extracting HTML code statistics.

### BRIEF DESCRIPTION OF THE DRAWINGS

Other embodiments of the invention will become apparent by reference to the detailed description in conjunction with the figures, wherein elements are not to scale so as to show the details more clearly, wherein like reference numbers indicate like elements throughout the several views, and wherein:

FIG. 1 shows a data sample according to an embodiment of the invention;

FIG. 2 shows data sample probabilities according to an embodiment of the invention;

FIG. 3 shows data sample probabilities according to an embodiment of the invention;

FIG. 4 shows data sample probabilities according to an embodiment of the invention;

FIG. 5 shows data sample probabilities according to an embodiment of the invention;

FIG. 6 shows data sample probabilities according to an embodiment of the invention;

FIG. 7 shows data sample probabilities according to an embodiment of the invention;

FIGS. 8A and 8B show data sample probabilities according to an embodiment of the invention;

FIG. 9 shows data sample probabilities according to an embodiment of the invention;

FIG. 10 shows data sample probabilities according to an embodiment of the invention;

FIG. 11 shows data sample probabilities according to an embodiment of the invention;

FIG. 12 shows data sample probabilities according to an embodiment of the invention;

FIG. 13 shows data sample probabilities according to an embodiment of the invention;

FIG. 14 shows data sample probabilities according to an embodiment of the invention;

FIG. 15 shows data sample probabilities according to an embodiment of the invention;

FIG. 16 shows data sample probabilities according to an embodiment of the invention;

FIG. 17 shows data sample probabilities according to an embodiment of the invention;

FIG. 18 shows a data sample loss function according to an embodiment of the invention;

FIG. 19 shows a data sample loss function according to an embodiment of the invention;

FIG. 20 shows a data sample loss function according to an embodiment of the invention;

FIG. 21 shows data sample probabilities according to an embodiment of the invention;

FIG. 22 shows nine ways to calculate the quantiles according to an embodiment of the invention;

FIG. 23 shows data sample probabilities according to an embodiment of the invention;

FIG. 24 shows data sample probabilities according to an embodiment of the invention;

FIG. 25 shows an example of word processing according to an embodiment of the invention;

FIG. 26 shows an example of word processing according to an embodiment of the invention;

FIG. 27 shows an example of word processing according to an embodiment of the invention;

FIG. 28 shows an example of word processing according to an embodiment of the invention; and

FIG. 29 shows an example of a domain classification process flow according to an embodiment of the invention.

### DETAILED DESCRIPTION

The system for detecting the malicious domain comprises two neural networks.

The first neural network was developed as a gradient-boosting classification tree and trained on more than thirty DNS features and six million domains. The network was designed to work with very large and complicated datasets, as described in the following chapter.

For simplicity, the gradient boosting algorithm will be explained using only one dimension, one feature and four data samples.

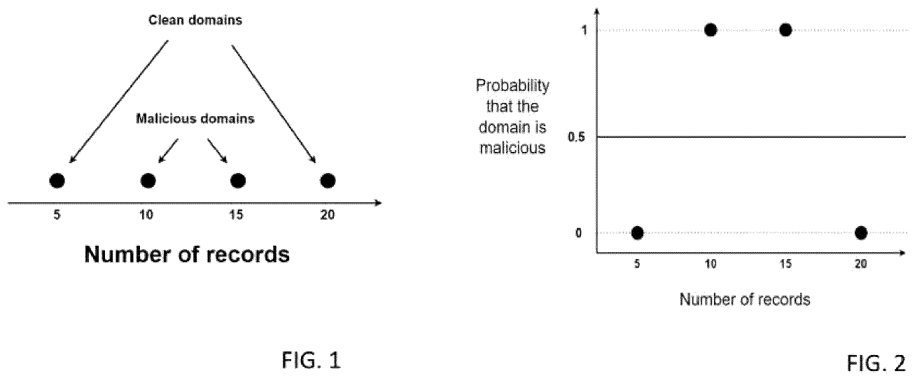

For the data sample from FIG. 1, the algorithm will make a default prediction of 0.5 since there is a 50% chance that a domain is malicious or not. Since the ground truth is known for the data samples (two malicious domains and two clean domains), their probability of being malicious is 0 or 1, as described in FIG. 2.

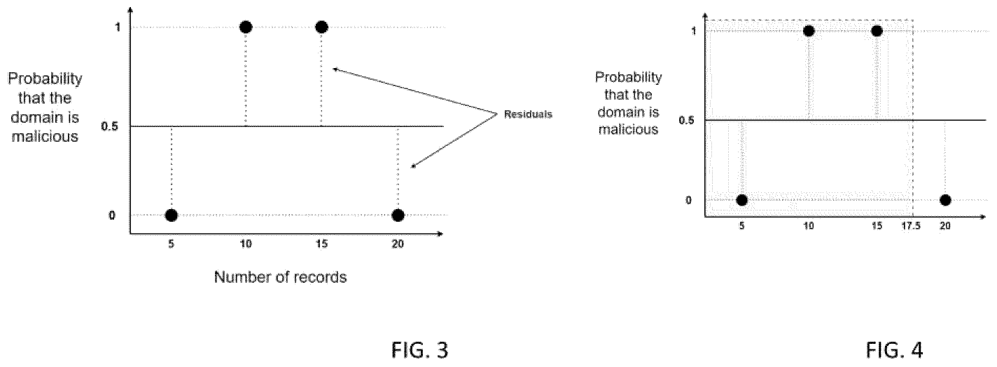

Since the initial prediction is 0.5 and the classes for samples are 0 or 1, the difference between ground truth and prediction is called Residual (the differences between Observed and Predicted values). It is a method for measuring the error and the quality of the prediction. See FIG. 3.

In order to build the trees, the algorithm starts as a single leaf by putting the Residual into the node. For each leaf, it calculates a Quality Score, named Similarity Score for the Residuals.

$$Similarity Score = \frac{{( \sum {Residuals}_{i} )}^{2}}{\sum [ Previous {Probability}_{i} \times ( 1 - Previous {Probability}_{i} ) ] + λ}$$

where λ (lambda) is a Regularization parameter.

For Residuals=−0.5, 0.5, 0.5, −0.5 and λ=0:

$$Similarity Score = \frac{{( - 0.5 + 0.5 + 0.5 - 0.5 )}^{2}}{\sum [ Previous {Probability}_{i} \times ( 1 - Previous {Probability}_{i} ) ] + 0} \\ Similarity Score = \frac{0}{\sum [ Previous {Probability}_{i} \times ( 1 - Previous {Probability}_{i} ) ] + 0}$$

$$Similarity Score = 0$$

The similarity score for the first leaf is 0. The algorithm can now split the Residuals into multiple groups to search for better results. See FIG. 4.

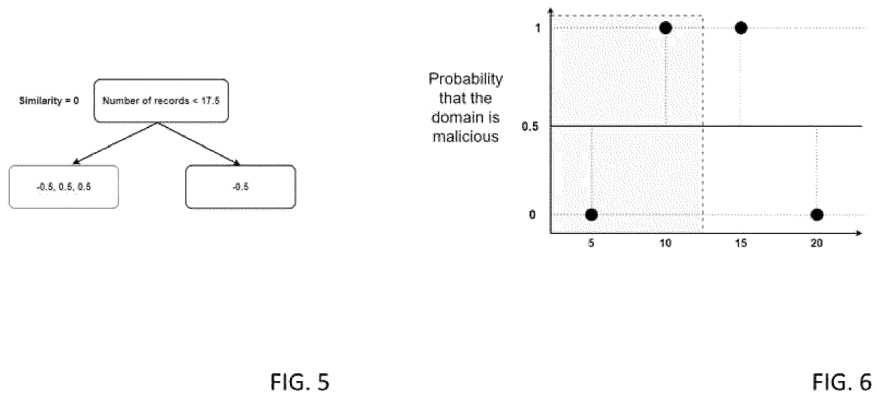

A threshold of 17.5 (the mean value between the values of the domains 20 and 15) will split the Residuals into two leaves. See FIG. 5.

$$Previous Probability = Prediction from the initial leaf = 0.5$$

$$Similarity Score Left Node = \frac{{( - 0.5 + 0.5 + 0.5 )}^{2}}{[ 0.5 \times ( 1 - 0.5 ) ] + [ 0.5 \times ( 1 - 0.5 ) ] + [ 0.5 \times ( 1 - 0.5 ) ] + 0}$$

$$Similarity Score Left Node = 0.33 \\ Similarity Score Right Node = \frac{{( - 0.5 )}^{2}}{[ 0.5 \times ( 1 - 0.5 ) ] + 0} \\ Similarity Score Right Node = 1$$

At this point, the algorithm needs a metric to quantify if the leaves cluster similar Residuals better than the root. The property is called Gain, and it aggregates the Similarity Scores.

Gain=Left_{Similarity}+Right_{Similarity}−Root_{Similarity}

Gain=0.33+1−0=1.33

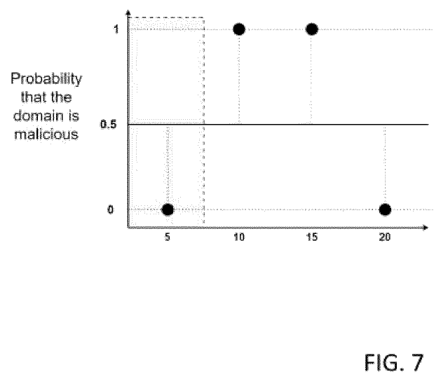

The algorithm needs to calculate the gain value for each threshold (17.5, 12.5, 7.5) and keep the one with the more significant value as the root node. See FIGS. 6 and 7.

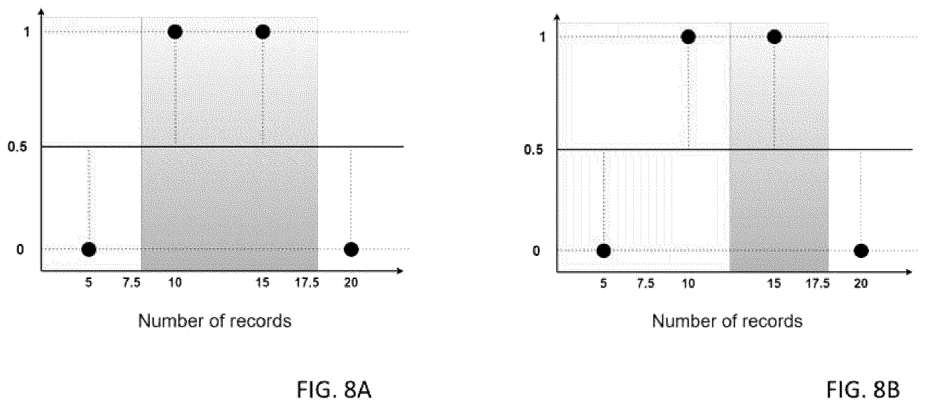

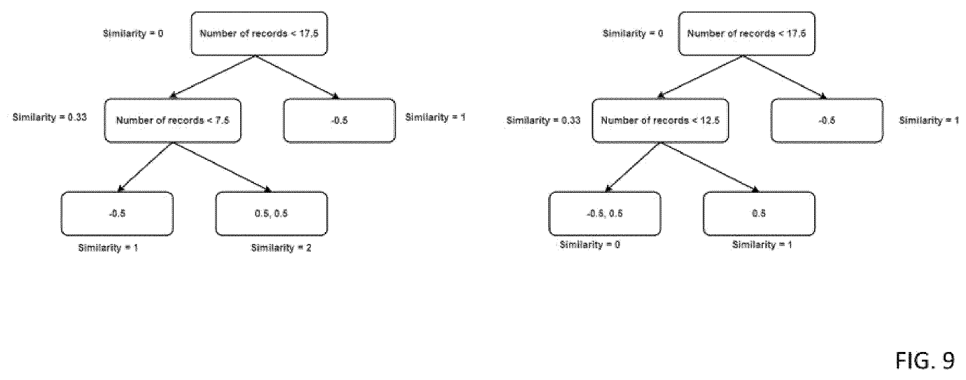

The largest Gain value can be achieved with a threshold of 17.5, which makes it the starting node. After deciding on the starting node, the same algorithm should be applied for the remaining nodes. See FIGS. 8 and 9.

The threshold lower than 7.5 has a better gain value and will be selected as the best candidate for the 2nd level node. The algorithm continues like that for the defined depth, which is six by default. The tree depth is a hyperparameter that will be optimized during training period.

Once the tree is done, there is a Prune method for dimensionality reduction. The algorithm Prunes the tree based on its Gain values. The terminology for Prune value is gamma (γ). The algorithm will calculate the difference between the Gain of the lowest branch and Prune value. If the difference is negative, the branch will be removed. For γ=3, all the branches will be removed, and all that would be left is the original prediction since the Gain for the second branch is 2.66, and the Gain for the first branch is 1.33. For γ=2, the tree will remain the same since the second branch is 2.66.

$$Gain - γ = \{ \begin{matrix}> 0 , & do not prune \\ < 0 , & prune\end{matrix}$$

Based on the below formula, lambda is a regularization parameter that reduces de similarity scores and the gain value implicitly. For a λ=1, the Gain values for the first and second branches will be 0.34 and 0.72, while for λ=0, they are 1.33 and 2.66. This implies that values for λ greater than 0 will reduce the sensitivity of the tree to individual observations by pruning and combining them with other observations.

$$Similarity Score = \frac{{( \sum {Residuals}_{i} )}^{2}}{\sum [ Previous {Probability}_{i} \times ( 1 - Previous {Probability}_{i} ) ] + λ}$$

The output of a leaf node can be calculated using the following formula

$$Output value = \frac{( \sum {Residuals}_{i} )}{\sum [ Previous {Probability}_{i} \times ( 1 - Previous {Probability}_{i} ) ] + λ}$$

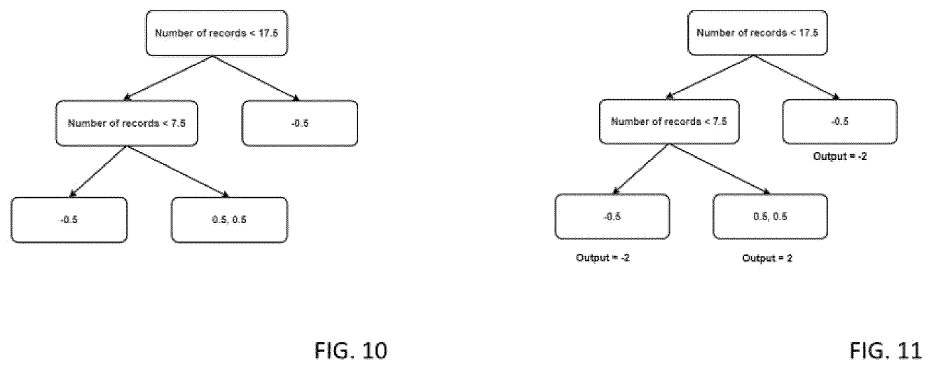

### See FIG. 10.

$$For λ = 0 , \\ Output value = \frac{( - 0.5 )}{[ 0.5 \times ( 1 - 0.5 ) ] + 0} = - 2 \\ For λ = 1 , \\ Output value = \frac{( - 0.5 )}{[ 0.5 \times ( 1 - 0.5 ) ] + 1} = - 0.4$$

When λ>0, it reduces the amount that a single observation adds to the new prediction. Thus, it reduces the prediction's sensitivity to isolated observations. See FIG. 11.

At this point, the first tree is ready. Based on that information, the algorithm can make a new Prediction. In order to build a new prediction, the algorithm should start from the initial prediction. Since the Predictions are in terms of the log(odds) and the leaf is derived from Probability, the results cannot be added together without a transformation.

$$( \frac{p}{1 - p} ) = odds$$

$$log ( \frac{p}{1 - p} ) = log ( odds )$$

$$For p = 0.5 ,$$

$$log ( \frac{0.5}{1 - 0.5} ) = log ( odds )$$

$$0 = log ( odds )$$

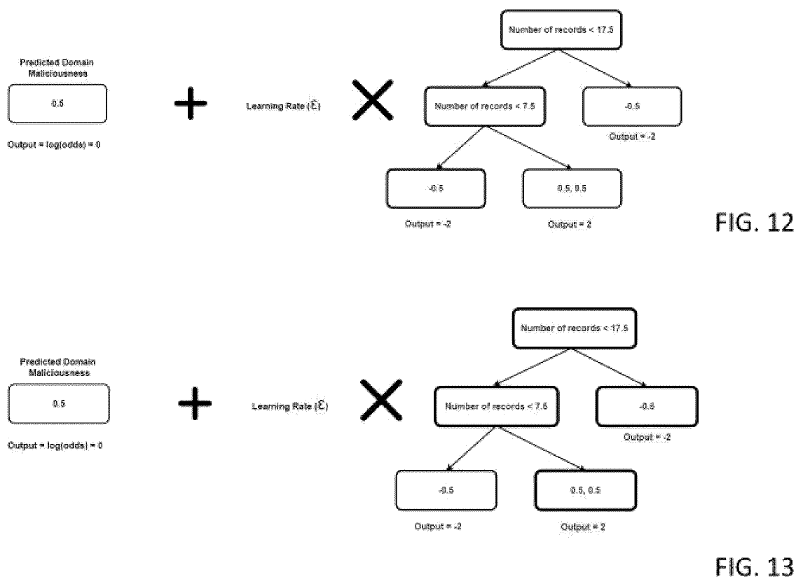

See FIG. 12.

log(odds) Prediction=log(odds) Original Prediction+ε×Tree Output Value

In order to determine the prediction value, the algorithm should calculate the sum of the original prediction with the output value scaled by the Learning Rate (the default value is 0.3). If the learning rate would not scale the output, their sum will end up as the original prediction. Thus, a learning rate is used to scale the contribution from the new tree, and its value is between 0 and 1. If the learning rate would not be used, the algorithm will end up with low Bias (the simplifying assumptions made by the model to make the target function easier to approximate) but very high Variance (the amount that the estimate of the target function will change given different training data).

log(odds) Prediction=0+0.3×(−2)=−0.6

To convert a log(odds) value into a probability, it needs to be plugged into a Logistic Function

$$Probability = \frac{{e}^{log ( odds )}}{1 + {e}^{log ( odds )}}$$

$$Probability = \frac{{e}^{- 0.6}}{1 + {e}^{- 0.6}} = 0.35$$

### See FIG. 13.

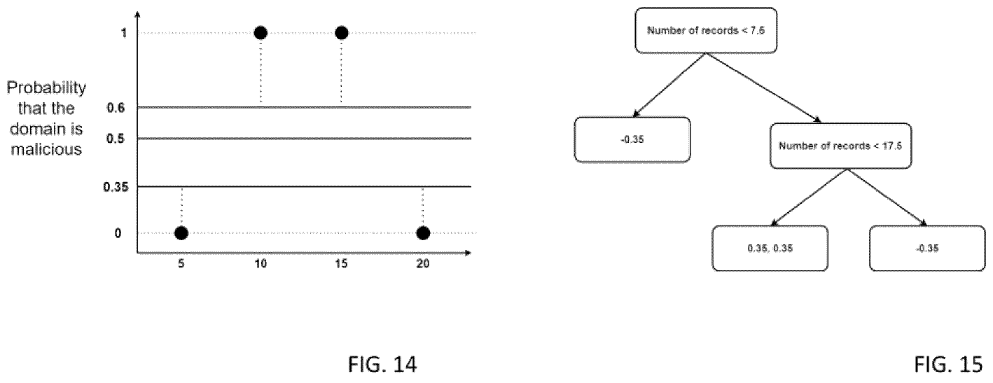

The algorithm should calculate the predicted output for each data sample based on its residual value. See FIG. 14.

The residuals are smaller than before, which means that the algorithm made a small step in the right direction. With new residuals, the algorithm can build new trees that will better fit the data. See FIG. 15

In the second tree, calculating the Similarity Score is different, considering that Previous Probabilities are no longer the same for all the observations (same for Output Value).

$$Similarity Score = \frac{{( \sum {Residuals}_{i} )}^{2}}{\begin{matrix}\sum [ Previous {Probability}_{i} \times \\ ( 1 - Previous {Probability}_{i} ) ] + λ\end{matrix}}$$

$$Similarity Score = \frac{{( \sum {Residuals}_{i} )}^{2}}{\begin{matrix}[ ( 0.3 5 ) \times ( 1 - 0.35 ) ] + [ ( 0.65 ) \times ( 1 - 0.65 ) ] + \\ [ ( 0. 65 ) \times ( 1 - 0.65 ) ] + [ ( 0.35 ) \times ( 1 - 0.35 ) ] + λ\end{matrix}}$$

After building another tree, the algorithm will make new predictions that will return smaller residuals and build new trees. It will keep building trees until the residuals are small enough or reach the maximum number of trees.

Mathematical Implementation

The Loss Function used in the classification process is the negative log—likelihood.

L(yᵢ,pᵢ)=−[yᵢ log(pᵢ)+(1−yᵢ)log(1−pᵢ)]

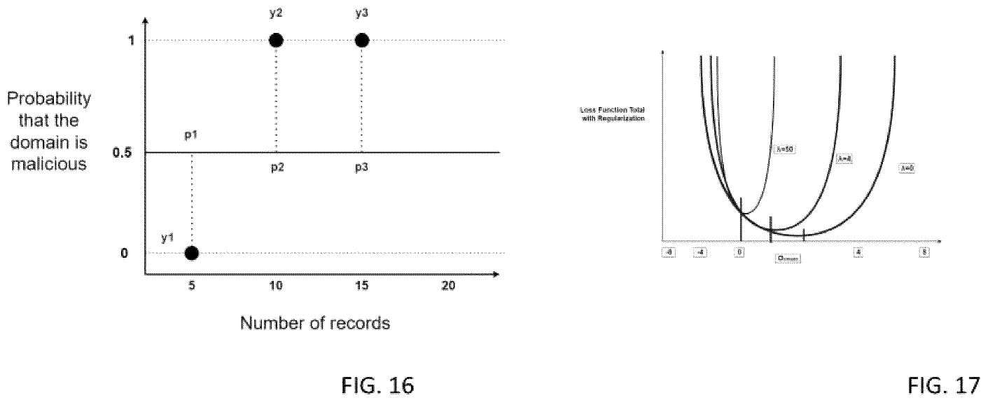

### See FIG. 16.

The algorithm uses the loss function to build trees by minimizing the following equation.

$$[ {\sum }_{i = 1}^{n} L ( {y}_{i} , {p}_{i} ) ] + γ T + \frac{1}{2} λ {O}_{value}^{2}$$

T is the number of terminal nodes or leaves in a tree, and A (gamma) is a user-defined penalty. It will not be used in future mathematic calculus since it is used in pruning, which takes place after the whole tree is built. For this reason, it plays no role in deriving the Optimal Output Values or Similarity Scores.

$$[ {\sum }_{i = 1}^{n} L ( {y}_{i} , {p}_{i} ) ] + \frac{1}{2} λ {O}_{value}^{2}$$

$$Loss Function + Regularization Term$$

The goal is to find an Output Value (Oᵥₐₗᵤₑ) for the leaf that minimizes the whole equation.

If different values are used for the output of the leaves for different residuals and different regularization values, the result will be as shown in the following graph. When the Regularization is 0, then the optimal Oᵥₐₗᵤₑ is at the bottom of the blue parabola, where the derivative is 0. If the A (lambda) is increased, the lowest point in the parabola shifts closer to 0. See FIG. 17.

To explain the math behind the loss function, it would be easier to remove the Regularization by setting A (lambda) to 0.

The algorithm uses the Second Order Taylor Approximation to determine the optimal Output Value.

$$[ {\sum }_{i = 1}^{n} L ( {y}_{i} , {p}_{i} ) ] + \frac{1}{2} λ {O}_{value}^{2}$$

$${p}_{i} = {p}_{i}^{0} + {O}_{value}$$

$$[ {\sum }_{i = 1}^{n} L ( {y}_{i} , {p}_{i}^{0} + {O}_{value} ) ] + \frac{1}{2} λ {O}_{value}^{2}$$

$$where ,$$

$$L ( {y}_{i} , {p}_{i}^{0} + {O}_{value} ) \approx L ( {y}_{i} , {p}_{i} ) + [ \frac{d}{{dp}_{i}} L ( {y}_{i} , {p}_{i} ) ] {O}_{value} + \frac{1}{2} [ \frac{d}{{dp}_{i}} L ( {y}_{i} , {p}_{i} ) ] {O}_{value}^{2}$$

and where, L(yᵢ, pᵢ) is the Loss Function for the previous prediction,

$$[ \frac{d}{{dp}_{i}} L ( {y}_{i} , {p}_{i} ) ]$$

is the first derivative of the Loss Function Gradient (g), and

$$\frac{{d}^{2}}{{dp}_{i}^{2}} L ( {y}_{i} , {p}_{i} )$$

is the second derivative of the Loss Function Hessian (h).

$$L ( {y}_{i} , {p}_{i}^{0} + {O}_{value} ) \approx L ( {y}_{i} , {p}_{i} ) + g {O}_{value} + \frac{1}{2} h {O}_{value}^{2}$$

$$[ {\sum }_{i = 1}^{n} L ( {y}_{i} , {p}_{i}^{0} + {O}_{value} ) ] + \frac{1}{2} λ {O}_{value}^{2}$$

The summation above is expanded as:

$$L ( {y}_{i} , {p}_{i}^{0} + {O}_{value} ) + L ( {y}_{2} , {p}_{2}^{0} + {O}_{value} ) + … + L ( {y}_{n} , {p}_{n}^{0} + {O}_{value} ) + \frac{1}{2} λ {O}_{value}^{2}$$

Plugging in the second order Taylor approximation for each Loss Function:

$$L ( {y}_{1} , {p}_{1}^{0} ) + {g}_{1} {O}_{value} + \frac{1}{2} {h}_{1} {O}_{value}^{2} + L ( {y}_{2} , {p}_{2}^{0} ) + {g}_{2} {O}_{value} + \frac{1}{2} {h}_{2} {O}_{value}^{2} + … + L ( {y}_{n} , {p}_{n}^{0} ) + {g}_{n} {O}_{value} + \frac{1}{2} {h}_{n} {O}_{value}^{2} + \frac{1}{2} λ {O}_{value}^{2}$$

The end objective is to find an Output Value that minimizes the Loss Function with Regularization. For this reason, the terms that do not contain the Output Value can be removed since they do not affect the optimal value.

$$L ( , {p}_{1}^{0} ) + {g}_{1} {O}_{value} + \frac{1}{2} {h}_{1} {O}_{value}^{2} + L ( , {p}_{2}^{0} ) + {g}_{2} {O}_{value} + \frac{1}{2} {h}_{2} {O}_{value}^{2} + … + L ( , {p}_{n}^{0} ) + {g}_{n} {O}_{value} + \frac{1}{2} {h}_{n} {O}_{value}^{2} + \frac{1}{2} λ {O}_{value}^{2}$$

$${g}_{1} {O}_{value} + \frac{1}{2} {h}_{1} {O}_{value}^{2} + {g}_{2} {O}_{value} + \frac{1}{2} {h}_{2} {O}_{value}^{2} + … + {g}_{n} {O}_{value} + \frac{1}{2} {h}_{n} {O}_{value}^{2} + \frac{1}{2} λ {O}_{value}^{2}$$

$$( {g}_{1} + {g}_{2} + … + {g}_{n} ) {O}_{value} + \frac{1}{2} ( {h}_{1} + {h}_{2} + … + {h}_{n} + λ ) {O}_{value}^{2}$$

To minimize a function, the algorithm should take the derivative with respect to the output value and set the derivative equal to 0.

$$\frac{d}{{dO}_{value}} ( {g}_{1} + {g}_{2} + … + {g}_{n} ) {O}_{value} + \frac{1}{2} ( {h}_{1} + {h}_{2} + … + {h}_{n} + λ ) {O}_{value}^{2} = 0$$

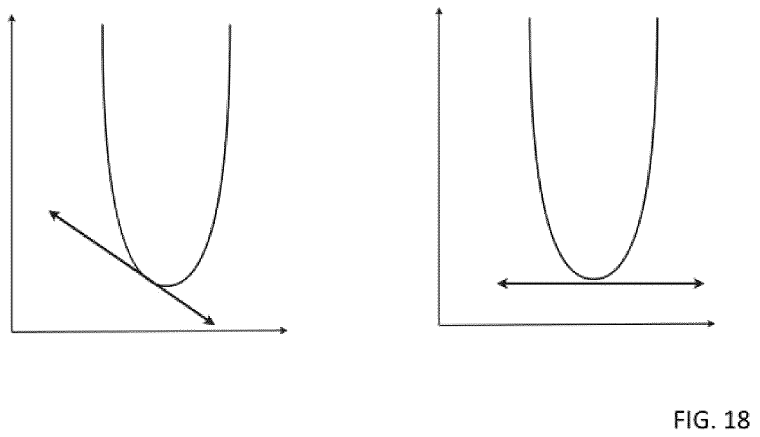

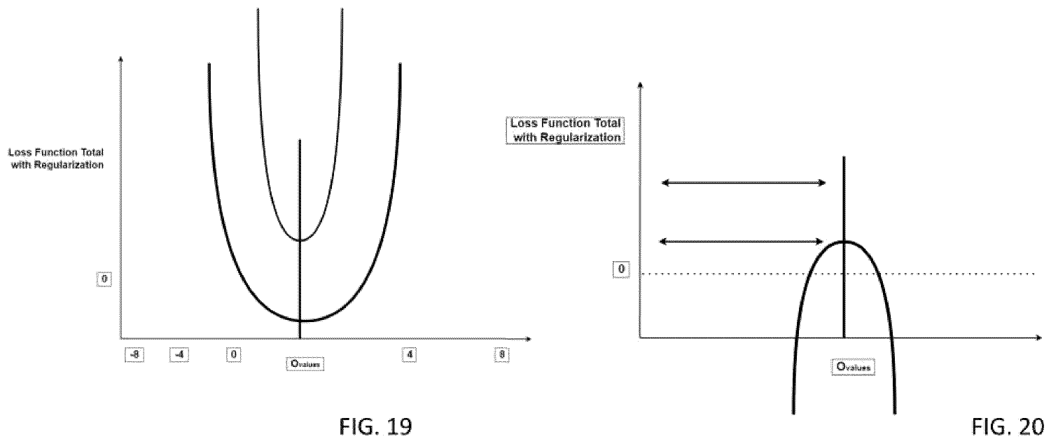

### See FIG. 18.

After derivation:

$$( {g}_{1} + {g}_{2} + … + {g}_{n} ) + ( {h}_{1} + {h}_{2} + … + {h}_{n} + λ ) {O}_{value}^{2} = 0$$

$${O}_{value} = \frac{- ( {g}_{1} + {g}_{2} + … + {g}_{n} )}{( {h}_{1} + {h}_{2} + … + {h}_{n} + λ )}$$

For the following Classification Loss Function:

$$L ( {y}_{i} , {p}_{i} ) = - [ {y}_{i} log ( {p}_{i} ) + ( 1 - {y}_{i} ) log ( 1 - {p}_{i} ) ]$$

$$L ( {y}_{i} , log {( odds )}_{i} ) = - {y}_{i} log ( odds ) + log ( 1 + {e}^{log ( odds )} )$$

$$\frac{d}{d log ( odds )} L ( {y}_{i} , log {( odds )}_{i} ) = - {y}_{i} \frac{{e}^{{log ( odds )}_{i}} )}{1 + {e}^{{log ( odds )}_{i}}}$$

$$\frac{{d}^{2}}{d log {( odds )}^{2}} L ( {y}_{i} , log {( odds )}_{i} ) = \frac{{e}^{log ( odds )} )}{1 + {e}^{log ( odds )}} \times \frac{1}{1 + {e}^{log ( odds )}}$$

$$since$$

$${p}_{i} = \frac{{e}^{{log ( odds )}_{i}} )}{1 + {e}^{{log ( odds )}_{i}}} ,$$

then the algorithm can convert log(odds) back to probabilities:

$$Gradient {g}_{i} = \frac{d}{d log ( odds )} L ( {y}_{i} , log {( odds )}_{i} ) = - {y}_{i} \frac{{e}^{log {( odds )}_{i}} )}{1 + {e}^{log {( odds )}_{i}}} = - ( {y}_{i} - {p}_{i} )$$

$$Hessian {h}_{i} = \frac{{d}^{2}}{d log {( odds )}^{2}} L ( {y}_{i} , log {( odds )}_{i} ) = \frac{{e}^{log {( odds )}_{i}} )}{1 + {e}^{log ( odds )}} \times \frac{1}{1 + {e}^{log ( odds )}} = {p}_{i} \times ( 1 - {p}_{i} )$$

$${O}_{v a l u e} = \frac{- ( {g}_{1} + {g}_{2} + … + {g}_{n )}}{( {h}_{1} + {h}_{2} + … + {h}_{n} + λ )}$$

$${O}_{v a l u e} = \frac{- ( - ( {y}_{1} - {p}_{1} ) + - ( {y}_{2} - {p}_{2} ) + … + - ( {y}_{n} - {p}_{n} ) )}{( {p}_{1} \times ( 1 - {p}_{1} ) + {p}_{2} \times ( 1 - {p}_{2} ) + … + {p}_{n} \times ( 1 - {p}_{n} ) + λ )}$$

$${O}_{v a l u e} = \frac{( {\sum Residual}_{i} )}{\sum [ Preνious {Probability}_{i} \times ( 1 - Previous {Probability}_{i} ) ] + λ}$$

For a Regression Loss Function:

$$L ( {y}_{i} , {p}_{i} ) = \frac{1}{2} {( {y}_{i} - {p}_{i} )}^{2}$$

$${g}_{i} = \frac{d}{d {p}_{i}} \frac{1}{2} {( {y}_{i} - {p}_{i} )}^{2} = - ( {y}_{i} - {p}_{i} )$$

$${h}_{i} = \frac{{d}^{2}}{d {p}_{i}^{2}} \frac{1}{2} {( {y}_{i} - {p}_{i} )}^{2} = \frac{d}{d {p}_{i}} - ( {y}_{i} - {p}_{i} ) = 1$$

$${O}_{v a l u e} = \frac{- ( - ( {y}_{1} - {p}_{1} ) + - ( {y}_{2} - {p}_{2} ) + … + - ( {y}_{n} - {p}_{n} ) )}{( 1 + 1 + … + 1 + λ )}$$

$${O}_{v a l u e} = \frac{Sum of Residuals}{N umber of Residuals + λ}$$

Now, the algorithm can calculate the Output Value for each leaf by plugging derivatives of the Loss Functions into the equation for the Output Value, but to grow the tree, the algorithm needs to derive the equations for the Similarity Score.

Remember that the algorithm derived the equation for the Oᵥₐₗᵤₑ by minimizing the sum of the Loss Functions plus the Regularization. Thus, depending on the Loss Function, optimizing it might be challenging, so it was approximated with a Second-Order Taylor Polynomial.

$$[ {\sum }_{i = 1}^{n} L ( {y}_{i} , {p}_{i}^{0} + {O}_{value} ) ] + \frac{1}{2} λ {O}_{ν a l u e}^{2}$$

That being said, starting from the above equation, the algorithm ends up with the below value, as proved before.

$$( {g}_{1} + {g}_{2} + … + {g}_{n} ) {O}_{value} + \frac{1}{2} ( {h}_{1} + {h}_{2} + … + {h}_{n} + λ ) {O}_{v a l u e}^{2}$$

Because the constants have been removed when deriving the equation, the end up equation is not equal to the starting one. However, if both equations are plotted on a graph, the same x-axis coordinate represented by the Oᵥₐₗᵤₑ tells the location of the lowest points in both parabolas. See FIG. 19.

$${O}_{v a l u e} = \frac{- ( {g}_{1} + {g}_{2} + … + {g}_{n} )}{( {h}_{1} + {h}_{2} + … + {h}_{n} + λ )}$$

The algorithm uses the simplified version to determine the Similarity Score. The first thing is to multiply everything by negative 1, which will flip the parabola over the horizontal line y=0.

$$- 1 \times [ ( {g}_{1} + {g}_{2} + … + {g}_{n} ) {O}_{v a l u e} + \frac{1}{2} ( {h}_{1} + {h}_{2} + … + {h}_{n} + λ ) {O}_{v a l u e}^{2} ]$$

$$- ( {g}_{1} + {g}_{2} + … + {g}_{n} ) {O}_{v a l u e} - \frac{1}{2} ( {h}_{1} + {h}_{2} + … + {h}_{n} + λ ) {O}_{value}^{2}$$

### See FIG. 20.

Now, the optimal Oᵥₐₗᵤₑ represents the x-axis coordinate for the highest point on the parabola, which is the Similarity Score. However, the Similarity Score used in the implementation is actually two times that number.

$$- ( {g}_{1} + {g}_{2} + … + {g}_{n )} {O}_{v a l u e} - \frac{1}{2} ( {h}_{1} + {h}_{2} + … + {h}_{n} + λ ) {O}_{v a l u e}^{2}$$

$${O}_{v a l u e} = \frac{- ( {g}_{1} + {g}_{2} + … + {g}_{n )}}{( {h}_{1} + {h}_{2} + … + {h}_{n} + λ )}$$

$$- ( {g}_{1} + {g}_{2} + … + {g}_{n )} \frac{- ( {g}_{1} + {g}_{2} + … + {g}_{n )}}{( {h}_{1} + {h}_{2} + … + {h}_{n} + λ )} - \frac{1}{2} {( {h}_{1} + {h}_{2} + … + {h}_{n} + λ ) [ \frac{- ( {g}_{1} + {g}_{2} + … + {g}_{n )}}{( {h}_{1} + {h}_{2} + … + {h}_{n} + λ )} ]}^{2}$$

$$\frac{( {g}_{1} + {g}_{2} + … + {g}_{n )}^{2}}{( {h}_{1} + {h}_{2} + … + {h}_{n} + λ )} - \frac{1}{2} ( {h}_{1} + {h}_{2} + … + {h}_{n} + λ ) \frac{( {g}_{1} + {g}_{2} + … + {g}_{n )}^{2}}{{( {h}_{1} + {h}_{2} + … + {h}_{n} + λ )}^{2}}$$

$$\frac{( {g}_{1} + {g}_{2} + … + {g}_{n )}^{2}}{( {h}_{1} + {h}_{2} + … + {h}_{n} + λ )} - \frac{1}{2} \frac{( {g}_{1} + {g}_{2} + … + {g}_{n )}^{2}}{( {h}_{1} + {h}_{2} + … + {h}_{n} + λ )}$$

$$Similarity Score = \frac{1}{2} \frac{( {g}_{1} + {g}_{2} + … + {g}_{n )}^{2}}{( {h}_{1} + {h}_{2} + … + {h}_{n} + λ )}$$

In the algorithm implementation, the % is omitted since the Similarity Score is a relative measure, and as long as every Similarity Score is scaled with the same amount, the results of the comparisons will be the same.

$$Similarity Score = \frac{( {g}_{1} + {g}_{2} + … + {g}_{n )}^{2}}{( {h}_{1} + {h}_{2} + … + {h}_{n} + λ )}$$

For the following Classification Loss Function:

$$L ( {y}_{i} , {p}_{i} ) = - [ {y}_{i} log ( {p}_{i} ) + ( 1 - {y}_{i} ) log ( 1 - {p}_{i} ) ]$$

$$Gradient {g}_{i} = \frac{d}{d log ( odds )} L ( {y}_{i} , log {( odds )}_{i} ) = - {y}_{i} \frac{{e}^{log {( odds )}_{i}} )}{1 + {e}^{log {( odds )}_{i}}} = - ( {y}_{i} - {p}_{i} )$$

$$Hessian {h}_{i} = \frac{{d}^{2}}{d log {( odds )}^{2}} L ( {y}_{i} , log {( odds )}_{i} ) = \frac{{e}^{log ( odds )} )}{1 + {e}^{log ( odds )}} \times \frac{1}{1 + {e}^{log ( odds )}} = {p}_{i} \times ( 1 - {p}_{i} )$$

$$Similarity Score = \frac{( - ( {y}_{1} - {p}_{1} ) + - ( {y}_{2} - {p}_{2} ) + … + - ( {y}_{n} - {p}_{n} ) )}{( {p}_{1} \times ( 1 - {p}_{1} ) + {p}_{2} \times ( 1 - {p}_{2} ) + … + {p}_{n} \times ( 1 - {p}_{n} ) + λ )}$$

$$Similarity Score = \frac{{( {\sum Residual}_{i} )}^{2}}{\sum [ Preνious {Probability}_{i} \times ( 1 - Previous {Probability}_{i} ) ] + λ}$$

For a Regression Loss Function:

$$L ( {y}_{i} , {p}_{i} ) = \frac{1}{2} {( {y}_{i} - {p}_{i} )}^{2}$$

$${g}_{i} = \frac{d}{d {p}_{i}} \frac{1}{2} {( {y}_{i} - {p}_{i} )}^{2} = - ( {y}_{i} - {p}_{i} )$$

$${h}_{i} = \frac{{d}^{2}}{{dp}_{i}^{2}} \frac{1}{2} {( {y}_{i} - {p}_{i} )}^{2} = \frac{d}{d {p}_{i}} - ( {y}_{i} - {p}_{i} ) = 1$$

$$Similarity Score = \frac{{( - ( {y}_{1} - {p}_{1} ) + - ( {y}_{2} - {p}_{2} ) + … + - ( {y}_{n} - {p}_{n} ) )}^{2}}{( 1 + 1 + … + 1 + λ )}$$

$$Similarity Score = \frac{Sum of {Residuals}^{2}}{N umber of Residuals + λ}$$

Optimization

The algorithm is very efficient with extensive datasets, as will be proved in this section.

The algorithm uses a Greedy Algorithm to build trees by setting up different threshold values. This works well for relatively small datasets but it is not fast enough for large amounts of data. For this reason, an Approximate Greedy Algorithm is better suited for large-scale datasets.

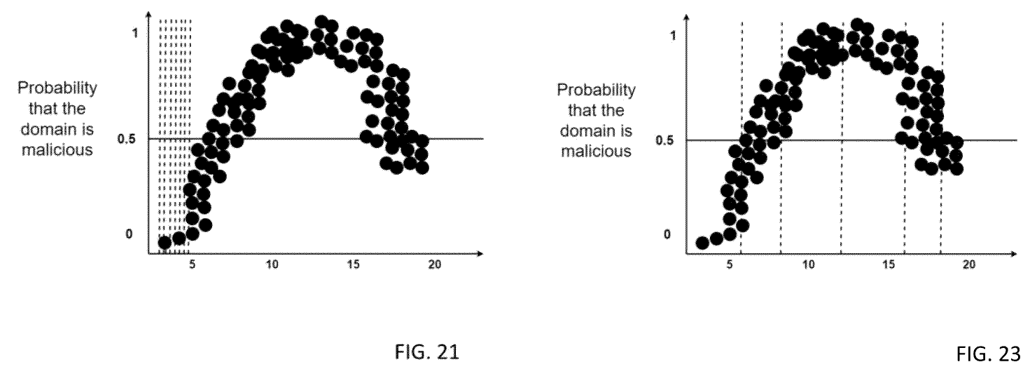

For the following dataset from the below image, a Greedy Algorithm will become slow since it will need to look at every possible threshold value. The dataset used in the following example only contains one feature. It will be very computationally expensive for a more complex dataset with more than 300 features to test every threshold. See FIG. 21.

The Approximate Greedy Algorithm uses quantiles to define different threshold levels. The easiest definition for quandle is the position where a sample is divided into equal-sized, adjacent subgroups. It can also refer to dividing a probability distribution into areas of equal probability. The median is a quantile; the median is placed in a probability distribution so that exactly half of the data is lower than the median and half of the data is above the median. The median cuts a distribution into two equal areas, and so it is sometimes called 2-quantile. Percentiles are quantiles that divide the data into 100 equally sized groups. The median will be called the 50th percentile.

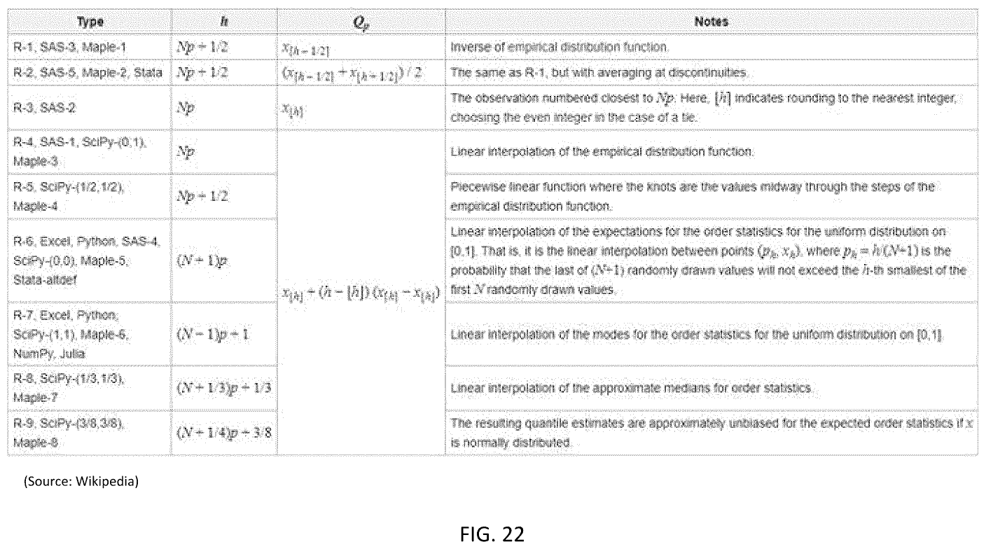

There are multiple ways to calculate the quantiles. Only R's quantile( ) function provides 9 different ways to calculate, each one resulting in slightly different results. Since it is not in the purpose of this technical review, the entire calculation details can be found in the table shown in FIG. 22.

The Approximate Greedy Algorithm in this algorithm means that instead of testing all possible thresholds, it only tests the quantiles. By default, the algorithm uses about 33 quantiles. There are about 33 quantiles and not precisely 33, because the algorithm uses Parallel Learning and Weighted Quantile Sketch, as will be explained. See FIG. 23.

When there is a large volume of that, that cannot be fitted into a computer's memory at one time, finding quantiles and sorting lists will become very slow. To solve this problem, a class of algorithms called Sketches can quickly create approximate solutions.

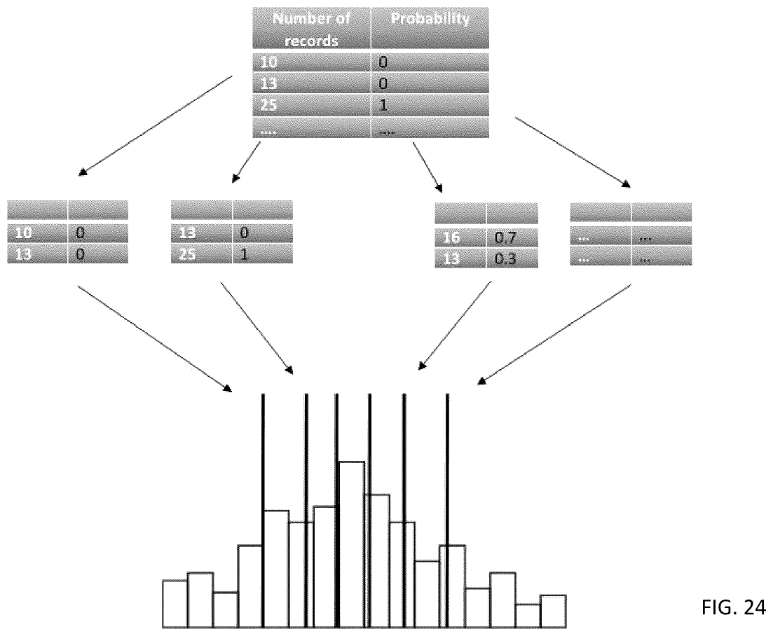

It can be split into small pieces for a very large dataset that will be processed on a network. The Quantile Sketch Algorithm combines the values for each splice and creates an approximate histogram. Based on the histogram, the algorithm can calculate approximate quantiles used in the Approximate Greedy Algorithm. See FIG. 24.

Usually, quantiles are set up so that the same number of observations are in each one. In contrast, for Weighted Quantiles, each observation has a corresponding weight, and the sum of the Weights are the same in each quantile. The weight for each observation is the 2^{nd} derivative of the Loss Function, which is referred as Hessian. For regression the weights are all equal to 1, which means that the weighted quantiles are just like normal quantiles and contain an equal number of observations. In contrast, for Classification the weights are:

Weight=Previous Probabilityᵢ×(1−Previous Probability)

In practice, weights are calculated after the tree is built.

| Number of records | Weight | Probability |
|---|---|---|
| 10 | 0.2 | 0 |
| 13 | 0.01 | 0 |
| 25 | 0.06 | 1 |
| . . . | . . . | . . . |

Every computer has a CPU (Central Processing Unit) that has a small amount of Cache Memory. The CPU can use this memory faster than any other memory in the computer. The CPU is also attached to a large amount of Main Memory (RAM: Random Access Memory). It is described as being fast, but it is slower than cache memory. The CPU is also attached to the Hard Drive. The Hard Drive can store more data but it is the slowest of all memory options. The goal is to maximize the processing on Cache Memory. The procedure is called Cache-Aware Access. The algorithm puts the Gradients and Hessian in the Cache so that it can rapidly calculate Similarity Scores and Output Values.

When the dataset is too large for the Cache and RAM, some of it must be stored on the Hard Drive. Since reading and writing data to a hard drive is slow, the algorithm tries to minimize these actions by compressing the data. The procedure is called Block for Out-of-Core Computation. Even if the CPU must spend time decompressing the data that comes from the Hard Drive, it can do it faster than the Hard Drive can read the data. Moreover, when there is more than one Hard Drive attached to the machine, the algorithm uses a database technique called Sharding to speed up the disk access. Then, when the CPU needs data, both drives can be reading data at the same time.

Moreover, the algorithm can speed up building trees by only looking at a random subset of features when deciding how to split the data.

The second neural network used for building the domain classifier is the skip—gram network with n—grams word embeddings.

Dataset

In natural language processing, as far as tasks are concerned (Classification, Machine translation, Cbow, Skip-gram, Natural Language Understating, etc.), the model is trained based on a dataset. The dataset is a collection of texts called Corpus in literature (body in Latin). This can be composed of groups of texts written in a single language or in multiple languages. There are various reasons for having multilingual Corpora (plural for Corpus), especially in text understanding and machine translation, where the correlation between words in multiple languages and their correlated synonyms should be well determined. For example, in English, the words ‘same’ and ‘equal’ are synonyms but translated into another language, they can result in different words.

The dataset highly influences the model's performance. For example, themed texts, like historical or modern (making use of neologisms), can affect the model's accuracy and text understanding results when used for classifying regular vocabulary.

Since the task is domain classification, there is no language in which the domains have a meaning. Even if many of them are based on a name or words from vocabulary like ‘example.com’, there are many randomly generated domains like ‘asfgfdewgfdsagtersdd.com’. Another example, the word ‘google’ was not in any vocabulary until recently, proving that domain names do not always have a meaning.

For those reasons, the corpus is composed exclusively of domains. The main task of the neural network is to understand the correlation between words in the corpus and calculate the probability of words and contexts in a sentence. Since domains don't have a meaning in most languages, a multilingual corpus would not be helpful.

This is a unique element in NLP and in cybersecurity, to train a neural network on an invented ‘language’, the language of the domains, and to train the network to understand this language.

The dataset is composed of 50 million domains. They are all labeled domains, but that is not relevant for this neural network since it was trained unsupervised.

On the contrary, when combining the tree-based neural network with the natural language processing network, the labelled training dataset was composed of 6 million domains.

1. 3 million→clean (benign) domains discovered by Heimdal Security through a ranking system. Most of them were highly used domains.

2. 3 million→malicious (malign) and active domains. There is a big challenge to find malicious domains still active. The mean lifespan of an infected website is seven days. After this period, most of the zero-day websites are taken down. For this reason, it was a real challenge to find this number of active hostile websites. Moreover, all of the infected domains had to be labeled and used so that the dataset is balanced. The categories from the malicious dataset are: “Command and Control”, “Phishing”, “Typo squatting”, and “General Malware”.

Natural Language Processing Model

The model is derived from the continuous skip-gram model introduced by Mikolov et al (Tomas Mikolov, 2013). Computers cannot understand words, they understand numbers, so a vectorial representation of those words is necessary. Each word will be represented by a vector whose values will be adjusted during the training.

For example, if the corpus will be represented by the following words: computer, engineer, house, dog, horse. Each embedding will have a corresponding vector.
computer→[1,0,0,0,0,0,0,0,0]
house→[0,1,0,0,0,0,0,0,0]
engineer→[0,0,1,0,0,0,0,0,0]
dog→[0,0,0,1,0,0,0,0,0]
horse→[0,0,0,0,1,0,0,0,0]

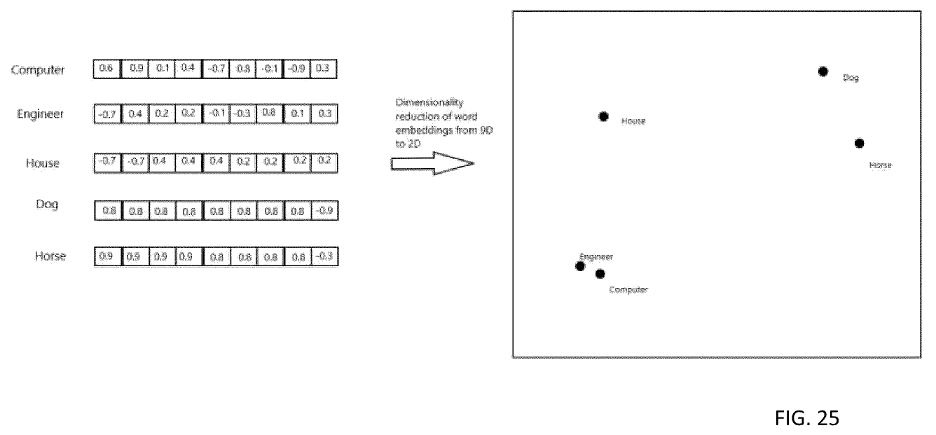

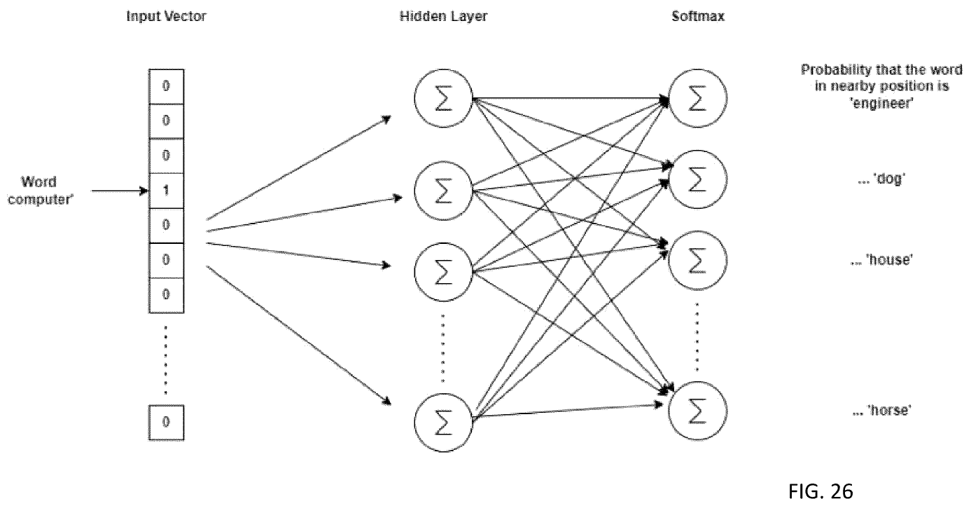

By the end of the training process, the word vectors should rearrange their values so that similar words will be close to each other in the multidimensional space, as shown in FIG. 25.

The phrases in the corpus determine the correlation between words. If the corpus contains phrases in which the words computer and horse are mutually related, the embeddings will be close in the multidimensional space. Hence the importance of a variate corpus, considering that the model will be as accurate as the dataset.

In practice, the computer engineers will use all the text in the training language, from Wikipedia, books, science articles, movie subtitles, emails, etc.

Since the model contains the domain's language, there will be no correlation between words, so the model should be adapted to subwords.

The original training algorithm proposed by Mikolov et al. for word embeddings fulfills two purposes, CBOW and Skip-Gram. Starting from a dataset of sentences, the algorithm chooses each word in the sentences and tries to predict its neighbors, also called the contexts. (Skip-gram). On the other hand, those contexts can be used to predict the current word (CBOW). The task needed for domains classification is Skip-gram since it is desired to determine variations of domains starting from a base. (google.com→goooogle.com→googleads.com→google.dk, etc.)

The model architecture is composed of one or multiple hidden layers trained to perform a task with a SoftMax head. The network is not used for the trained task, and its only goal is to learn the weights in the hidden layers. The main advantage of this type of architecture is the unsupervised learning method because a supervised learning method would imply labeling the whole dataset. A labeling system would require a human to read and input the correlation between words in all the existing text in a language. That task would be close to impossible.

There is no dimensionality reduction layer during the training process. Since the input vector is formed by the number of words in the dictionary (50 million rows in the present corpus), each word will have a number of features (number of neurons in the hidden layers, 300). The output vector is the same size as the input, and each word in the input will get an assigned probability in the output.

At the end of the training process, only the hidden layer weight matrix is kept and used as word embeddings. The output layer is a SoftMax regression classifier that is no longer useful after the training.

Since the dataset is composed only of domains and no sentences, the algorithm proposed initially by Milkov et al. (Tomas Mikolov, 2013) cannot perform well. For this reason, an approach close to Mikolov in (Piotr Bojanowski, 2017) at Facebook AI Research is better suited.

Bojanowski et al. (Piotr Bojanowski, 2017) proposed a model that, given a word vocabulary of size W, the model will learn a vectorial representation for each w E {1, . . . ,W} by maximizing a log-likelihood function between words and contexts (words surrounding w).

$${\sum }_{t = 1}^{T} {\sum }_{c ∈ {𝒞}_{t}} log p ( {w}_{c} \vert {w}_{t} )$$

The previously described model determines the probability of a context word using a SoftMax function.

$$p ( {w}_{c} \vert {w}_{t} ) = \frac{{e}^{s ( {w}_{t} , {w}_{c} )}}{{\sum }_{j = 1}^{W} {e}^{s ( {w}_{t} , j )}}$$

Since multiple context words cannot be predicted from the center word (the dataset is composed only of domains), the model should be adapted to a different task as in Markov et al. 2017 (Piotr Bojanowski, 2017) using a binary logistic loss obtained from the negative log-likelihood.

$${\sum }_{t = 1}^{T} [ {\sum }_{c ∈ {𝒞}_{t}} ℓ ( 𝓈 ( {w}_{t} , {w}_{c} ) ) + {\sum }_{n ∈ {𝒩}_{t , c}} ℓ ( - 𝓈 ( {w}_{t} , n ) ) ]$$

The most important feature of this network is the sub word model, a separate word representation that also considers the internal structure of words. Domains are words with multiple variations from a legit domain like google.com, an attacker can register a lookalike domain like googgle.com. This type of attack is called typosquatting, in which an attacker uses a spelling error to mislead the user into thinking that he is on a legit website. The most spread typosquatting is the dot extraction. A domain like ‘www.example.com’ can be reproduced as ‘wwwexample.com’, and that missing dot can trick the user into arriving on a phishing website. Usually, the big companies buy all the correlated domains of their websites, but there are too many variations most of the time.

Each word is represented by a bag of character n-gram summed with the word itself. For a word w, Gw⊂{1, . . . , G} is the set of n-grams of w. The scoring function will become:

$$𝓈 ( w , c ) = {\sum }_{g ∈ {𝒢}_{w}} {z}_{g}^{⊤} {v}_{c} .$$

Natural Language Processing Model Prediction and Performance

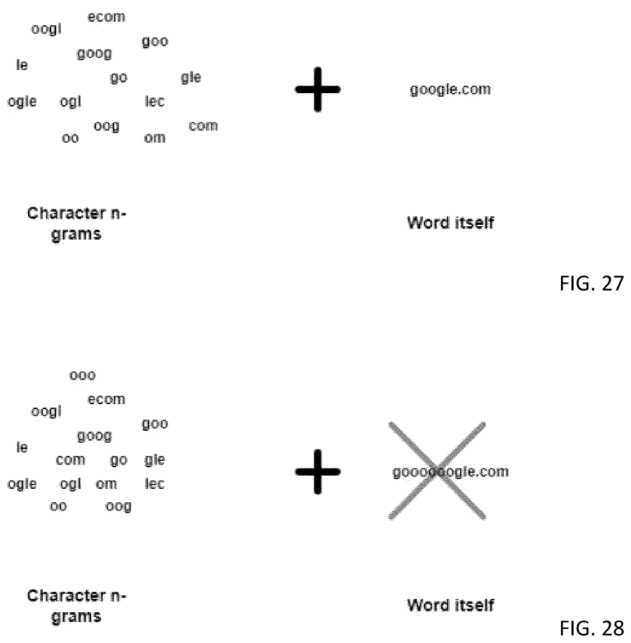

Using character-level n-grams, the model will exploit the sub-word information, increasing accuracy. In this way, vectors can be built for unseen words, like domains. The following figure shows an example of word embeddings creation during the model training period using the domain “google.com” from corpus. See FIG. 27.

At the inference (literature word for applying knowledge from a trained network to determine a new result, different from the training set) level, when the model should extract the embeddings for a newly generated domain like ‘goooooogle.com’, since the domain is a zero-day not in the corpus, the final word vector will be composed of the sum of n-grams. See FIG. 28.

With solid and proper trained embeddings, the domains “google.com” and ‘goooooogle.com’ should be close to each other in the multi-dimensional feature space since they are similar and share almost the same set of n-grams.

Since it's an unsupervised learning model, the accuracy of the embeddings cannot be measured, and it is only possible to estimate the accuracy of the performed task, which is irrelevant after training.

Even so, it can be measured how robust the embeddings are by calculating the distance between similar domains in the feature space. Multiple algorithms can calculate the distance between vectors in a multi-dimensional space, like Euclidian distance, Cosine Similarity, Manhattan distance, Soft Cosine Similarity, Dot Product, etc.

The implementation pipeline used Cosine Similarity to measure the distance between word vectors.

$$cosine similarity = {𝒮}_{𝒞} ( A , B ) := cos ( θ ) = \frac{A \cdot B}{‖ A ‖ ‖ B ‖} = \frac{{\sum }_{i = 1}^{B} {A}_{i} {B}_{i}}{\sqrt{{\sum {A}_{i}^{2}}_{i = 1}^{n}} \sqrt{{\sum {B}_{i}^{2}}_{i = 1}^{n}}} ,$$

After the training period, the similarity of multiple domains was measured, where some of them were already in the dataset and some of them were randomly generated.

A part of the results can be seen in the following table. It describes the top 10 correlated domains in the feature spaces based on the input using cosine similarity.

Input Domain

| Output | google.com | fdnmgkfd.com |
|---|---|---|
| 1 | googlec.com | fdsfd.com |
| 2 | google-adware.com | fdgfd.com |
| 3 | gooogle.com | fd4d.com |
| 4 | goooogle.com | fdd.com |
| 5 | googletune.com | fd7qz88ckd.com |
| 6 | google-sale.com | fdsyd.com |
| 7 | googlewale.com | fdg-ltd.com |
| 8 | googledrie.com | fdrs-ltd.com |
| 9 | goooooogle.com | fcbd.com |
| 10 | goolge.com | fcb88d.com |

The domain ‘google.com’ was in the original dataset. When used in prediction, the results show that the network was able to learn and is not underfitted since the results are similar.

The second domain is a random number of characters with the top-level domain ‘.com’. Those types of domains are used in C&C attacks. The results show that the network is not overfitted, and it generalizes well on data never seen in the dataset.

Based on that information, the embeddings are strong enough to be used in a classifier.

The resulting embeddings will be concatenated with sparse data features and used in the tree boost classifier previously described.

The invention uses two very powerful neural networks to analyze, interpret and understand zero-day threats (threats that are so new/recent that cybersecurity vendors are not aware of them).

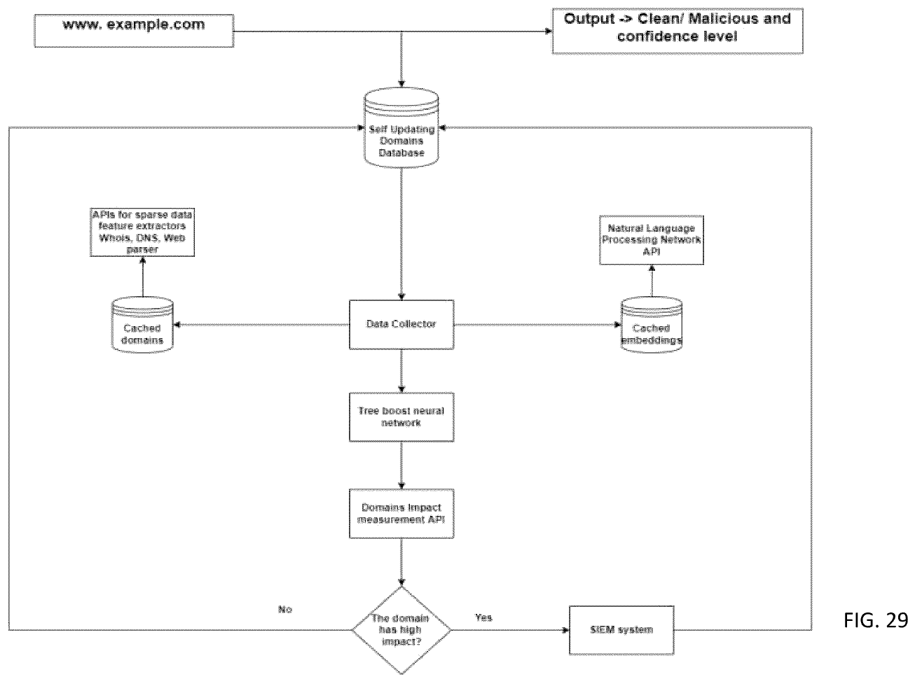

The invention achieves synergies from data engineering, machine learning, and research. It is a complex suite of multiple algorithms and programming techniques described in the following chart. The diagram flow in FIG. 29 shows the process of classifying a domain using the described software for predicting malicious domains.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A computerized method for calculating the probability of a domain being malicious based on an input dataset, the method comprising:
data extracting, including extracting from the input dataset at least two types of input data comprising:
network data comprising one or more of WHOIS data, DNS data, Reverse PTR data, Domain Ranking data and popularity data, and Domain Authority data; and
Domain Word embeddings data;
data preprocessing, including transforming the network data from sparse to dense;
data preprocessing, including transforming the Domain Words embeddings data into vectorial representations using a trained neural network; and
processing the preprocessed network data and Domain Words embeddings data through a trained tree-based neural network to determine a probability of the domain being malicious.

2. The method according to claim 1 wherein the trained neural network is trained unsupervised using a model to predict a target context based on a nearby word.

3. The method according to claim 1 wherein the data preprocessing step for transforming the Domain Words embeddings data into vectorial representations further comprises:
data preprocessing for representing words as vectors using n-grams; and
data preprocessing for filling in missing data.

4. The method according to claim 1 wherein a data processing algorithm uses similarity scores, gains and thresholds for determining the probability of the domain being malicious.

5. The method according to claim 1 wherein a classifier uses a probability distribution to determine a risk factor.

6. The method according to claim 1 further comprising using a Bayesian probability system for determining a risk score of a domain.

7. The method according to claim 1 performed using a probability distribution system for cybersecurity.

8. The method according to claim 1 including a process for reading data in batches for optimizing computer resources through which the method is implemented.

9. The method according to claim 1 including a process for minimizing memory consumption by splitting data reading and data processing in CPU, RAM, Cache and HD memory.

10. The method according to claim 1 further comprising parallel learning and inference based on splitting data in quantiles.

11. The method according to claim 1 used for training a hierarchical classifier comprising a binary tree having leaf nodes, wherein each leaf node represents a context word code generated with a Huffman tree algorithm.

12. The method according to claim 1 further comprising implementing a machine learning pipeline adapted to:
generate random trees and calculate a gain and similarity score for each random tree based on a threshold,
calculate an output value and adjust weights based on an error rate (loss function), and
calculate a needed adjustment for improving accuracy based on a test dataset through a second-order Taylor approximation between the error rate (loss function), a gradient (first derivative of the loss function) and a hessian (second derivative of the loss function).

13. (canceled)
